(19) United States
(12) Patent Application Publication
(10) Pub. No.: US 2025/0071711 A1
(43) Pub. Date: Feb. 27, 2025

(54) STORING AUTHENTICATION DATA ON AUSF

(71) Applicant: T-Mobile USA, Inc., Bellevue, WA (US)

(72) Inventors: Subramania Kaushik, Bellevue, WA (US); Anil Kumar Mariyani, Ashburn, VA (US)

(21) Appl. No.: 18/455,974

(22) Filed: Aug. 25, 2023

(51) Int. Cl. H04W 60/00; H04W 12/04; H04W 12/06

(52) U.S. Cl. CPC H04W 60/00; H04W 12/04; H04W 12/06

(57) ABSTRACT

Techniques for authenticating user equipment (UE) in a Fifth-Generation (5G) network are discussed herein. A UE can connect with a 5G network and can send a registration request to an authentication server function (AUSF) of the network. The AUSF can request multiple authentication vectors from a unified data management (UDM) function, which can use a 5G-AKA (authentication and key management) procedure to generate authentication vectors. The AUSF can receive and store a subset of the authentication vectors at the AUSF (or another location) and can forward an authentication vector to an access and mobility management function (AMF) to subsequently authenticate the UE. Later, when the UE leaves the 5G network (e.g., because of a handover) and returns to the 5G network, the AUSF can re-authenticate the UE without additional signaling to the UDM to generate or otherwise determine additional authentication vectors, thereby saving additional signaling in the core network.

### BACKGROUND

Modern terrestrial telecommunication systems include heterogeneous mixtures of second, third, and fourth generation (2G, 3G, and 4G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. Telecommunications systems may include fifth generation (5G) cellular-wireless access technologies to provide improved bandwidth and decreased response times to a multitude of devices that may be connected to a network.

The increased availability and performance characteristics of fifth generation (5G) networks have greatly enhanced the communication experiences of users. In some environments, however, the relative capabilities of 4G networks and 5G networks may result in handovers from 5G to 4G and, as environment, use, and characteristics vary, handovers back from 4G to 5G. The frequency of handovers has greatly increased signaling among core network nodes and instances where a user equipment (UE) registers with and authenticates to the network.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a diagram of a telecommunication network having a core network (e.g., having a combined 4G/5G core network) and 4G and 5G radio access technologies (RATs) available to user equipment (UE) via access networks, the nodes of the core network engaging in signaling and data retention to handle handovers in a manner that optimizes user experience and resource usage.

FIG. 2 is a message flow diagram showing a subset of core network nodes and the messages among these nodes and devices to generate and store authentication data at an authentication server function (AUSF) when a UE attaches to a 5G base station and registers with a core network.

FIG. 3 is a message flow diagram showing a subset of core network nodes and the messages among these nodes and devices to use authentication data stored at an AUSF to suppress additional signaling by and between such core network nodes.

FIG. 4 is a schematic diagram of a computing device capable of implementing functionality of one or more nodes of the core network.

FIG. 5 depicts an example process for storing and using authentication data in accordance with the techniques discussed herein.

### DETAILED DESCRIPTION

Techniques for authenticating user equipment (UE) in a Fifth-Generation (5G) network are discussed herein. For example, when a UE attaches to a 5G network, the UE can send a registration request to the network to register with the network. In some examples, the registration request can ultimately be received by an authentication server function (AUSF), which can send an authentication get request to a unified data management (UDM) function, which can use a 5G-AKA (authentication and key management) procedure to generate authentication vectors at the UDM to provide to the AUSF. The AUSF can store a subset of the authentication vectors at the AUSF (or another location) and can forward an authentication vector to the access and mobility management function (AMF) to subsequently authenticate the UE. Later, when the UE leaves the 5G network (e.g., because of a handover) and returns to the 5G network, the UE can re-authenticate at the network. Again, the UE can send a registration request to the network, which can be ultimately received at the AUSF, which may include previously-stored authentication data. Rather than sending additional signaling to the UDM to generate or otherwise determine additional authentication vectors, the AUSF can send a stored authentication vector to the AMF to authenticate the UE, thereby saving additional signaling in the core network.

In some examples, in response to a registration request from a UE, the AUSF can determine whether authentication vectors associated with the UE are stored at the AUSF or at a storage location accessible by the AUSF. If no such authentication vectors are found, the AUSF can request a plurality of authentication vectors from the UDM. In some examples, the AUSF can request a static number of authentication vectors (e.g., two vectors, five vectors, ten vectors, and the like). In some examples, the AUSF can request a number of authentication vectors based on load information associated with the core network and/or based on an expected number of registration requests to be received from the UE. For example, if an expected number of registration requests is expected to be high (or above a threshold) and a congestion level is expected to be above a threshold (e.g., a number of signaling messages is above a threshold), the AUSF may increase a number of authentication vectors to be requested, which may minimize subsequent requests and any associated signaling messages. Accordingly, the techniques discussed herein can dynamically vary a number of authentication vectors to be requested based on current and/or historical network conditions and performance.

In some examples, the techniques discussed herein can provide improvements to the functioning of computers in a network and/or can improve network performance. For example, the techniques discussed herein can result in network call optimizations to reduce signaling on an N12 interface and/or to reduce signaling on an N13 interface. In some examples, the techniques discussed herein can reduce signaling by and between the AUSF and the UDM and/or the unified data repository (UDR). In some examples, the techniques discussed herein can improve registration response times by using stored authentication vectors rather than waiting for generation and/or transmission of additional authentication vectors in response to additional registration requests. Additional improvements are discussed throughout this disclosure.

The techniques discussed herein can be implemented in the context of protocols associated with one or more of 3G, 4G, 4G LTE, and/or 5G protocols. In some examples, the network implementations can support standalone architectures, non-standalone architectures, dual connectivity, carrier aggregation, etc. Example implementations are provided below with reference to the following figures.

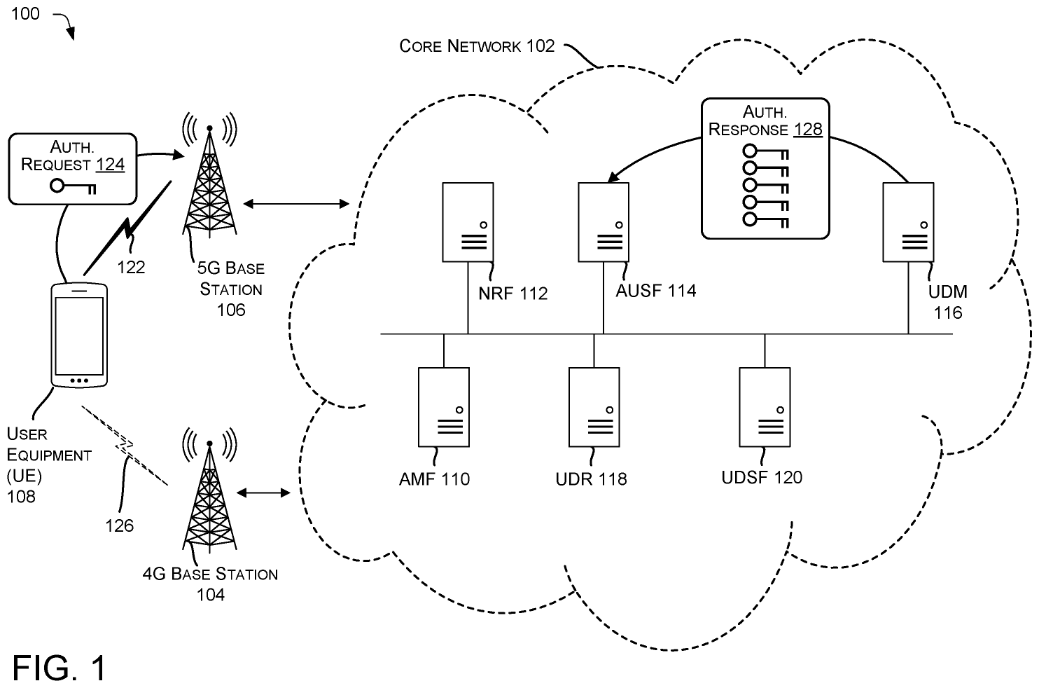

FIG. 1 is a diagram of a telecommunication network 100 having a core network 102 and Forth-Generation (4G) and Fifth-Generation (5G) radio access technologies (RATs) (base stations 104 and 106, respectively) available to user equipment (UE) 108 via access networks, the nodes of the core network 102 engaging in signaling and data retention to handle handovers in a manner that optimizes user experience and resource usage.

As illustrated, the UE 108 can connect to the 4G base station 104 (e.g., an eNodeB, or an eNB) or to a 5G base station 106 (e.g., a gNodeB, or a gNB) of the telecommunication network 100 and may be directed from one to the other through handover operations. The base stations 104 and 106 can be connected to the core network 102. The core network 102 can include, but is not limited to, an access and mobility management function (AMF) 110, a network repository function (NRF) 112, an authentication server function (AUSF) 114, a unified data management (UDM) 116, a unified data repository (UDR) 118, and/or an unstructured data storage function (UDSF) 120. In some examples, the core network 102 can be a core network that supports combined functions of 4G and 5G operations. In some examples, the core network 102 is a 5G core network that is separate from another core network devoted primarily to 4G core network features. Additional details of the core network 102 are discussed throughout this disclosure.

In some examples, the UE 108 can be any device that can wirelessly connect to the telecommunication network. In some examples, the UE 108 can be a mobile phone, such as a smart phone or other cellular phone. In other examples, the UE 108 can be an augmented reality device (e.g., a device (e.g., glasses, a smartphone, a headset, etc.) capable of running augmented reality application(s)), a personal digital assistant (PDA), a media player, a tablet computer, a gaming device, a smart watch, a hotspot, a personal computer (PC) such as a laptop, desktop, or workstation, or any other type of computing or communication device.

In various implementations, 4G and 5G base stations 104 and 106 may be co-located at a same cell site or at different cell sites and may each, offer connectivity to the UE 108 and any other UEs in proximity and capable of connecting to that radio access technology. Based on factors such as the location of the UE 108, the number of UEs utilizing the spectrum of the radio access technology, and the types of services those UEs are using, either of the 4G base station 104 or the 5G base station 106 may offer a better user experience at a different point in time, leading to handovers of the UE 108 between the 4G base station 104 and the 5G base station 106. The rules and thresholds governing the handovers may in some circumstances lead to frequent handovers. These frequent handovers in turn result in an increased signaling burden on the core network 102.

In some implementations, the core network 102 includes nodes and devices from both 4G core networks and 5G core networks. As shown, the core network 102 includes at least AMF 110, NRF 112, AUSF 114, UDM 116, UDR 118, and/or UDSF 120. The core network 102 may also include serving gateways (SGw), packet data network gateways (PGw), session management functions (SMF), user plane function (UPF), policy control function (PCF), or one or more nodes of an Internet protocol multimedia subsystem (IMS), such as a call session control function (CSCF) and its nodes (proxy CSCF (P-CSCF), interrogating CSCF (I-CSCF), and serving CSCF (S-CSCF)) or a policy and charging rule function (PCRF). The different ones among the 4G core network nodes and 5G core network nodes may support their respective base stations, corresponding one of the 4G base station 104 or the 5G base station 106 and, to support handovers, may communicate with each other over various interfaces.

As noted above, the core network 102 may authenticate the UE 108 when the UE 108 attaches to the network and/or when the UE 108 performs a handover from the 4G base station 104 to the 5G base station 106. In some examples, when the UE 108 attaches to the 5G base station 106 (e.g., illustrated by a connection 122 between the UE 108 and the 5G base station 106), the UE 108 can send an authentication request 124 to the 5G base station 106. In some examples, the authentication request 124 can be in response to an initial attach request to the core network 102, a handover from the 4G base station 104 to the 5G base station 106 (illustrated by breaking a connection 126 between the UE 108 and the 4G base station 104 and establishing the connection 122 between the UE 108 and the 5G base station 106), and the like.

In some examples, the authentication request 124 can include encrypted authentication data from the UE 108, such as an IMSI (international mobile subscribe identity), SUPI (subscription permanent identifier), a MAC (media access control) address, a hardware identifier, a subscriber identifier, an identifier based on a SIM (subscriber identity module) or an eSIM), and the like.

In some examples, the authentication request 124 can be received by the core network 102, which can trigger the UDM 116 to generate an authentication response 128 to send to the AUSF 114. In some examples, the authentication response 128 can include a plurality of authentication vectors (e.g., 5G AKA (authentication and key agreement) vectors). As discussed herein, the AUSF 114 can store some or all of the authentication data (e.g., the authentication vectors) and can forward one or more vectors to another node in the core network 102 to authenticate the UE 108 in response to the authentication request 124. After such authentication vectors are stored by the AUSF 114, subsequent authentication requests can be expedited and signaling can be reduced (e.g., eliminated) by using the stored authentication data rather than requesting the generation of additional vectors.

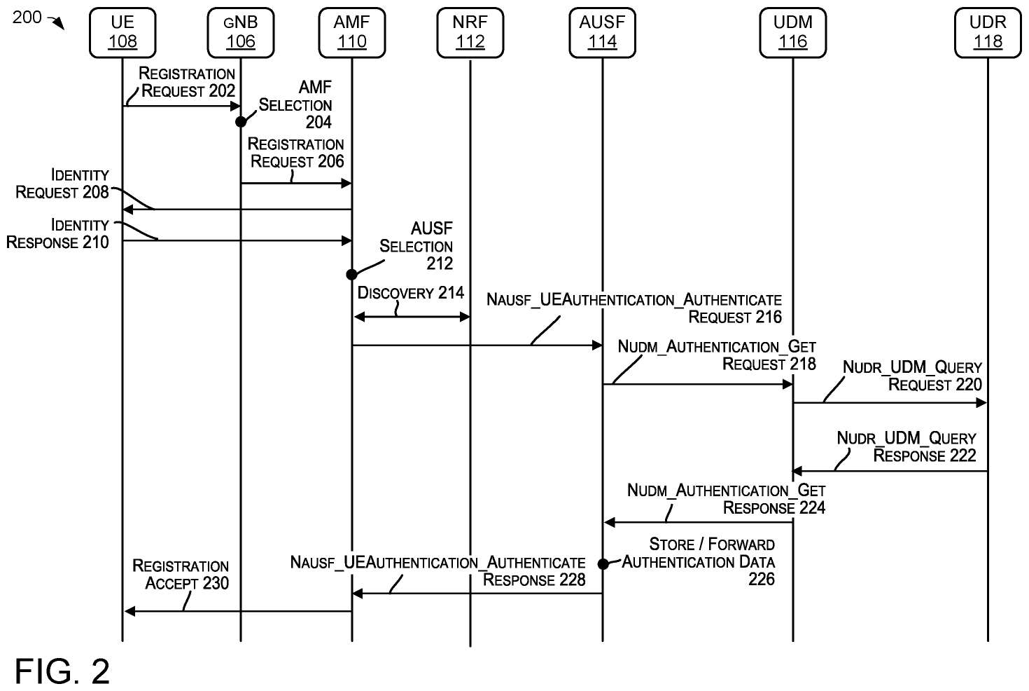

Additional details of the authenticating the UE 108 are provided in connection with FIGS. 2-5 and throughout this disclosure.

FIG. 2 is a message flow diagram 200 showing a subset of core network nodes and the messages among these nodes and devices to generate and store authentication data at an authentication server function (AUSF) 114 when a UE 108 attaches to a 5G base station 106 and registers with a core network 102.

As illustrated, the UE 108 can send a registration request 202 to the 5G base station 106 (also referred to as the gNB 106). In some examples, sending the registration request 202 can be in response to the UE 108 attaching to the gNB 106 for the first time or in response to the UE 108 returning to the gNB 106 after previously attaching to the gNB 106 (e.g., after one or more handovers between the 4G base station 104 and the 5G base station 106). In some examples, the registration request 202 can include authentication information, such as IMSI, SUPI, MAC address or any identifier associated with the UE 108. In some examples, the authentication information included in the registration request 202 can be encrypted.

Next, the gNB 106 can select an AMF at 204. In some examples, the AMF selection 204 can be based on a location of the UE 108, subscriber information, network load levels, latency, bandwidth, and the like. In some examples, an AMF can be selected from a pool of available AMFs.

After selecting an AMF in the operation 204, the gNB 106 can send a registration request 206 to the AMF 110. In some examples, the gNB 106 can forward the registration request 202 as the registration request 206.

Next, in response to receiving the registration request 206, the AMF 110 can send an identity request 208 to the UE 108. In response to the identity request 208, the UE 108 can send an identity response 210. In some examples, if identity information is not included in the registration request 202, the identity response 210 can include, but is not limited to information, such as an IMSI, SUPI, MAC address and/or any identifier associated with the UE 108. In some examples, the data in the identity response 210 can be encrypted.

The AMF 110 can select an AUSF at operation 212 (AUSF selection 212). In some examples, the AUSF selection 212 can be based on a location of the UE 108 and/or a location of the AMF 110, subscriber information, network load levels, latency, bandwidth, and the like. In some examples, an AUSF can be selected from a pool of available AUSFs.

At operation 214, a discovery operation can occur by and between the AMF 110, the NRF 112, and/or other devices or functions. In some examples, the discovery 214 operation can include, but is not limited to, accessing a repository including the 5G elements of the core network 102 and the services provided by each, providing profiles of available network function instances and their services to inquiring functions, allowing consumer network functions to discover other provider network function instances in the core network 102, and/or allow network function instances to track the status of other network function instances.

After the AMF 110 discovers the AUSF 114 in the core network 102, the registration process can continue with operation 216, in which the AMF 110 sends a Nausf_UE Authentication_Authenticate Request 216 (e.g., also referred to as an “authentication request” or a “request”) to the UDM 116. In some examples, the request 216 can include some or all of the information included with or associated with the registration request 202 and/or the identity response 210. In some examples, the AMF 110 can query the AUSF 114 on an N12 interface.

The AUSF 114 can send a Nudm_Authentication_Get Request 218 (e.g., a “get request” or a “request”) to the UDM 116. In some examples, the request 218 is configured to request multiple 5G AKA vectors from the UDM 116 via an N13 interface.

In some examples, in response to the request 218, the UDM 116 can issue a Nudr_UDM_Query Request 220 (e.g., a “query request” or a “request”) to the UDR 118, and in response, the UDR 118 can send a Nudr_UDM_Query Response 222 (e.g., a “query response” or a “response”) to the UDM 116.

The UDM 116 can generate authentication vectors based on the response 222, and in some examples the UDM 116 can send a plurality of authentication vectors to the AUSF 114 via the Nudm_Authentication_Get Response 224 (e.g., a “get response” or a “response”). In some examples, the number of authentication vectors can be static, fixed, or otherwise predetermined. In some examples, the number of authentication keys can be dynamically determined based on current or expected traffic levels, current or expected numbers of handovers, and the like. In some examples, the authentication vectors can be generated in accordance with one or more of a 5G AKA method, an EAP-AKA' method, and/or an EAP-TLS authentication method.

In some examples, the AUSF 114 can be a common AUSF servicing multiple UDM slices or UDM segments in the network. Further, in some examples, the authentication vectors received at the AUSF 114 can be restricted or otherwise limited to being stored at or on devices associated with the AUSF 114 in the same slice or segment. That is, in some examples the response 224 can include a UDM identifier such that the storage of the authentication vectors is limited to the AUSF 114 associated with the UDM identifier.

At 226 the AUSF 114 can store and/or forward some or all of the authentication vectors received in the response 224 at the AUSF 114. In some examples, the AUSF 114 can store some or all of the authentication vectors at the UDSF 120 associated with the AUSF 114.

The AUSF 114 can send a Nausf_UEAuthentication_Authenticate Response 228 to the AMF 110, which can authenticate the UE 108 on the basis of the registration request 202, the identity response 210, and/or based on the authentication vector received from the AUSF 114. After authenticating the UE 108, the AMF 110 can send a registration accept 230 to the UE 108. If the AMF 110 does not authenticate the UE 108 the AMF 110 can prevent the UE 108 from continuing the connection with the gNB 106.

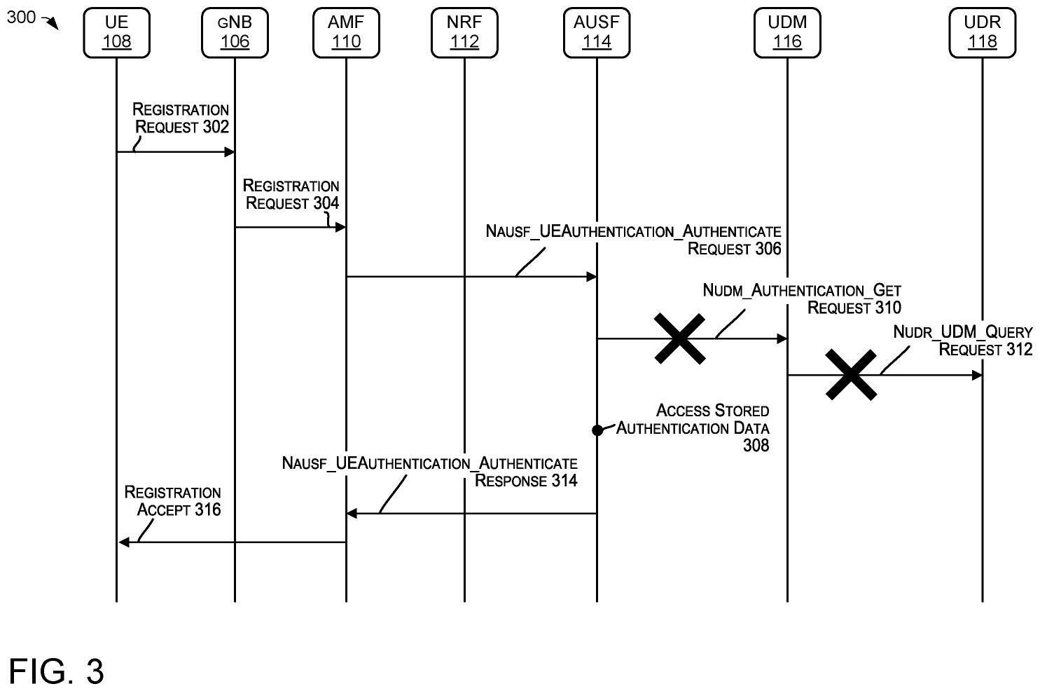

FIG. 3 is a message flow diagram 300 showing a subset of core network nodes and the messages among these nodes and devices to use authentication data stored at an AUSF to suppress additional signaling by and between such core network nodes.

In some examples, the messages in FIG. 3 occur following the operations illustrated in FIG. 2. That is, the messages in FIG. 3 occur after a first registration request has been sent by a UE 108 accessing the core network 102 such that there are authentication vectors stored at the AUSF 114 (or at a local storage location associated with the AUSF 114, such as the UDSF 120).

As illustrated, the UE 108 sends a registration request 302 to the gNB 106. In some examples, the UE 108 may be returning to the gNB 106 after a previous handover to a 4G base station (e.g., the 4G base station 104).

The gNB 106 can receive the registration request 302 and can forward a registration request 304 (based on the request 302) to the AMF 110.

The AMF can send a Nausf_UEAuthentication_Authenticate Request 306 to the AUSF 114. In response to the request 306, the AUSF 114 can search for stored authentication vectors associated with the UE 108. In an example when the operations in FIG. 3 occur after the operations in FIG. 2, the AUSF 114 will have stored authentication vectors associated with the UE 108. Accordingly, the AUSF will access stored authentication data 308, which avoids additional signaling with the UDM 116 and the UDR 118. For example, accessing stored authentication data in operation 308 obviates the AUSF 114 from sending the Nudm_Authentication_Get Request 310 and the UDM 116 from sending the Nudr_UDM_Query Request 312. Of course, refraining from sending messages 310 and 312 also obviates any response messages, which further illustrates the improvements provided by the techniques discussed herein.

The AUSF 114, after accessing stored authentication data 308, can send a Nausf_UEAuthentication_Authenticate Response 314 to the AMF 110, which in turn can send a registration accept 316 to the UE 108 to allow the UE 108 to connect to the gNB 106.

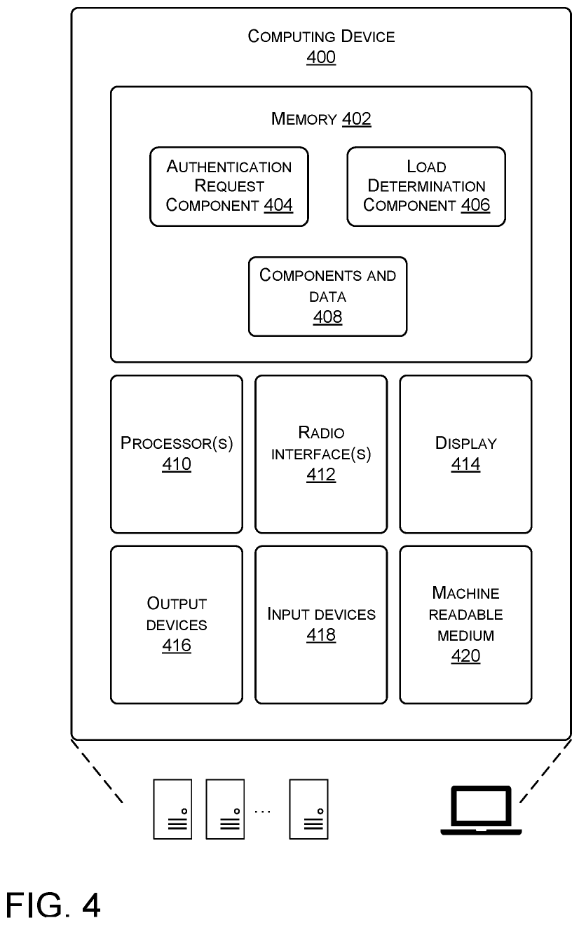

FIG. 4 is a schematic diagram of a computing device 400 capable of implementing functionality of one or more nodes of the core network. In some examples, the computing device 400 can represent the AMF 110, the NRF 112, the AUSF 114, the UDM 116, the UDR 118, and/or the UDSF 120. As shown, the computing device 400 can have memory 402 storing an authentication request component 404, a load determination component 406 and/or 124, and other components and data 408. The computing device 400 can also comprise processor(s) 410, radio interfaces 412, a display 414, output devices 416, input devices 418, and/or a machine readable medium 420.

In various examples, the memory 402 can include system memory, which may be volatile (such as RAM), non-volatile (such as ROM, flash memory, etc.) or some combination of the two. The memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 400. Any such non-transitory computer-readable media may be part of the computing device 400.

In some examples, the authentication request component 404 can include functionality to manage authentication requests from a UE in a core network. In some examples, the authentication request component 404 can receive an authentication request from a UE attempting to attach to, connect with, or otherwise establish a communication with a 5G network. The authentication request component 404 can receive the request and extract or otherwise determine information identifying the UE. In some examples, the authentication request component 404 can include a deconcealing function to decrypt or determine information associated with the UE. In some examples, the component 404 can include a concealing function as well. The component 404 can determine if authentication vectors are stored in memory (e.g., associated with the AUSF 114) and if so, the component 404 can provide an authentication vector to a requesting function (e.g., the AMF 110). If the component 404 determines that there are no authentication vectors stored in accessible memory (e.g., local memory, local storage, local cache, memory associated with a particular network slice, geographic region, or segment), the authentication request component 404 can send a request for authentication vectors to the UDM 116 to generate authentication vectors (e.g., in accordance with a 5G-AKA method and/or other authentication methods).

In some examples, the authentication request component 404 can receive authentication vectors generated by a network component, such as the UDM 116, and can store the vector(s) in local storage (or locally-accessible storage). In some examples, the authentication request component 404 can determine (e.g., in combination with the load determination component 406 or using other heuristics or machine learned models) that a number of vectors associated with a UE is below a threshold and can proactively request additional vectors to be generated by the UDM 116. In some examples, the authentication request component 404 can request a static number of authentication vectors (e.g., two, three, five, ten, or other number), and in some examples, the authentication request component 404 can request any number of vectors (e.g., as determined by the load determination component 406, other heuristics, or models).

In some examples, the load determination component 406 can include functionality to determine a load of components, signaling levels, or other metrics, and/or can determine a number of authentication vectors to request. In some examples, the load determination component 406 can determine when to request authentication vectors (e.g., even when a non-zero number of authentication vectors are “unused” and stored on the AUSF 114). For example, in some cases, if a signaling level for an N12 and/or an N13 interface is above a threshold (e.g., if a number of messages per unit of time is above a threshold, which may indicate congestion) the load determination component 406 may determine to increase a number of authentication vectors to request to minimize the number of subsequent requests to other components of the core network. In some examples, if an expected number of handovers is above a threshold (e.g., a number of handovers within a period of time) the load determination component 406 can determine to vary (e.g., increase) the number of requested authentication vectors to store additional vectors in advance.

In some examples, the load determination component 406 can determine a number of vectors to request based on a location of the UE in the network (e.g., near an edge, near an area with frequent handovers, etc.), a subscriber status (e.g., roaming or a home subscriber), UE capabilities (e.g., 4G/5G capable, dual connectivity capable, and the like). Of course, these are just examples and the load determination component 406 can determine a number of authentication vectors to request based on any factors discussed herein and/or contemplated by a person of ordinary skill in the art.

The other components and data 408 can be utilized by the computing device 400 to perform or enable performing any action taken by the computing device 400. The components and data 408 can include a UE platform, operating system, and applications, and data utilized by the platform, operating system, and applications.

In various examples, the processor(s) 410 can be a central processing unit (CPU), a graphics processing unit (GPU), or both CPU and GPU, or any other type of processing unit. Each of the one or more processor(s) 410 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 410 may also be responsible for executing all computer applications stored in the memory 402, which can be associated with common types of volatile (RAM) and/or nonvolatile (ROM) memory.

The radio interfaces 412 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 412 can be compatible with multiple radio access technologies, such as 5G radio access technologies and 4G/LTE radio access technologies. Accordingly, the radio interfaces 412 can allow the computing device 400 to connect to various components as described herein.

The display 414 can be a liquid crystal display or any other type of display commonly used in computing devices. For example, display 414 may be a touch-sensitive display screen, and can then also act as an input device or keypad, such as for providing a soft-key keyboard, navigation buttons, or any other type of input. The output devices 416 can include any sort of output devices known in the art, such as the display 414, speakers, a vibrating mechanism, and/or a tactile feedback mechanism. Output devices 416 can also include ports for one or more peripheral devices, such as headphones, peripheral speakers, and/or a peripheral display. The input devices 418 can include any sort of input devices known in the art. For example, input devices 418 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 420 can store one or more sets of instructions, such as software or firmware, that embodies any one or more of the methodologies or functions described herein. The instructions can also reside, completely or at least partially, within the memory 402, processor(s) 410, and/or radio interface(s) 412 during execution thereof by the computing device 400. The memory 402 and the processor(s) 410 also can constitute machine readable media 420.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

FIGS. 2, 3, and 5 illustrate example processes and sequence diagrams in accordance with examples of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order, omitted, and/or performed in parallel to implement the processes.

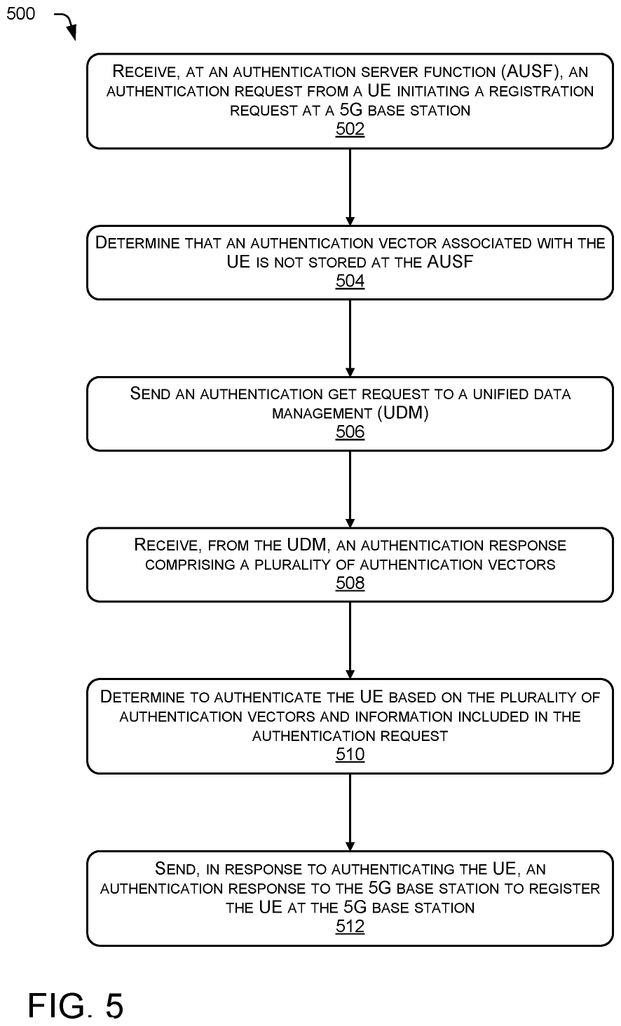

FIG. 5 depicts an example process 500 for storing and using authentication data in accordance with the techniques discussed herein. Some or all of the process 500 may be performed by one or more components as illustrated in FIGS. 1, 2, 3, and 4, as described herein. For example, some or all of process 500 may be performed by the computing device 114 of FIG. 1.

At operation 502, the process may include receiving, at an authentication server function (AUSF), an authentication request from a UE initiating a registration request at a 5G base station. In some examples, the operation 502 can be performed in response to a UE connecting to a 5G base station for a first time or connecting to a 5G base station after using all the stored authentication vectors. In some examples, the process 500 can generally correspond to the operations illustrated in FIG. 2.

At operation 504, the process may include determining that an authentication vector associated with the UE is not stored at the AUSF. In some examples, the operation 504 can include partially deconcealing or decrypting identification information associated with the UE to determine an identity associated with the UE and to determine that there are no authentication vectors associated with the UE and stored at the AUSF. In some examples, the AUSF may not have a deconcealing or decrypting function and may use the authentication request to determine whether authentication vectors are stored in the AUSF or not.

At operation 506, the process may include sending an authentication get request to a unified data management (UDM). In some examples, the operation 506 can include determining a load of the various components or signaling pathways of the core network and can determine a number of authentication vectors to request as part of the authentication get request. In some examples, the operation 506 can request a static number of vectors, such as two, three, five, ten, or the like.

At operation 508, the process may include receiving, from the UDM, an authentication response comprising a plurality of authentication vectors. In some examples, the UDM can generate authentication vectors in accordance with a 5G-AKA methodology. In some examples, the UDM can generate authentication vectors using an EAP-AKA' and/or an EAP-TLS authentication method. In some examples, the authentication response can include or can otherwise be associated with a network slice identifier (or segment identifier, region identifier, or the like) to restrict dissemination of the authentication vectors to particular slices, segments, and/or geographic regions.

At operation 510, the process may include determining to authenticate the UE based on the plurality of authentication vectors and information included in the authentication request. In some examples, the operation 510 may include comparing authentication information received from the UE with authentication information received from the UDM to determine whether to authenticate the UE. In some examples, the operation 510 can include selecting one of the authentication vectors to send to another network function (e.g., the AMF 110) while storing the remaining vectors in a storage location limited to and/or accessible by the AUSF 114.

At operation 512, the process may include sending, in response to authenticating the UE, an authentication response to the 5G base station to register the UE at the 5G base station.

### Conclusion

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein. For instance, techniques described in FIGS. 2, 3, and 5 can be combined in various ways.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter.

While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, at an authentication server function (AUSF), an authentication request from a user equipment (UE) initiating a registration request at a Fifth Generation (5G) base station;
determining that an authentication vector associated with the UE is not stored at the AUSF;
sending, in response to determining that the authentication vector is not stored at the AUSF, an authentication get request to a unified data management (UDM);
receiving, from the UDM, an authentication response comprising a plurality of authentication vectors;
determining to authenticate the UE based on comparing information included in the authentication request with at least one authentication vector included in the authentication response; and
sending, in response to authenticating the UE, an authentication response to the 5G base station to register the UE at the 5G base station.

2. The method of claim 1, wherein the at least one authentication vector is a first authentication vector and the authentication response includes at least one second authentication vector, the method further comprising:
storing the at least one second authentication vector at the AUSF.

3. The method of claim 1, wherein the at least one authentication vector is a first authentication vector and the authentication response includes at least one second authentication vector, the method further comprising:
storing the at least one second authentication vector at an unstructured data storage function (UDSF).

4. The method of claim 1, further comprising:
receiving the authentication request via an N12 interface.

5. The method of claim 1, further comprising:
sending the authentication get request via an N13 interface.

6. The method of claim 1, wherein the AUSF is a common AUSF in communication with a plurality of UDMs that are associated with respective geographic regions.

7. The method of claim 1, wherein the authentication response includes five authentication and key agreement (AKA) vectors.

8. The method of claim 1, further comprising:
determining a load level associated with the UDM; and
requesting a number of authentication vectors based on the load level;
wherein the authentication get request comprises the number of authentication vectors to be generated by the UDM.

9. A system comprising:
one or more processors; and
one or more non-transitory computer-readable media storing computer-executable instructions that, when executed by the one or more processors, cause the system to perform operations comprising:
receiving, at an authentication server function (AUSF), an authentication request from a user equipment (UE) initiating a registration request at a Fifth Generation (5G) base station;
determining that an authentication vector associated with the UE is not stored at the AUSF;
sending, in response to determining that the authentication vector is not stored at the AUSF, an authentication get request to a unified data management (UDM);
receiving, from the UDM, an authentication response comprising a plurality of authentication vectors;
determining to authenticate the UE based on comparing information included in the authentication request with at least one authentication vector included in the authentication response; and
sending, in response to authenticating the UE, an authentication response to the 5G base station to register the UE at the 5G base station.

10. The system of claim 9, wherein the at least one authentication vector is a first authentication vector and the authentication response includes at least one second authentication vector, the operations further comprising:
storing the at least one second authentication vector at the AUSF.

11. The system of claim 9, wherein the at least one authentication vector is a first authentication vector and the authentication response includes at least one second authentication vector, the operations further comprising:
storing the at least one second authentication vector at an unstructured data storage function (UDSF).

12. The system of claim 9, the operations further comprising:
receiving the authentication request via an N12 interface; and
sending the authentication get request via an N13 interface.

13. The system of claim 9, wherein the AUSF is a common AUSF in communication with a plurality of UDMs that are associated with respective geographic regions.

14. The system of claim 9, the operations further comprising:
determining a load level associated with the UDM; and
requesting a number of authentication vectors based on the load level;
wherein the authentication get request comprises the number of authentication vectors to be generated by the UDM.

15. One or more non-transitory computer-readable media storing instructions executable by one or more processors, wherein the instructions, when executed, cause the one or more processors to perform operations comprising:
receiving, at an authentication server function (AUSF), an authentication request from a user equipment (UE) initiating a registration request at a Fifth Generation (5G) base station;
determining that an authentication vector associated with the UE is not stored at the AUSF;
sending, in response to determining that the authentication vector is not stored at the AUSF, an authentication get request to a unified data management (UDM);
receiving, from the UDM, an authentication response comprising a plurality of authentication vectors;
determining to authenticate the UE based on comparing information included in the authentication request with at least one authentication vector included in the authentication response; and
sending, in response to authenticating the UE, an authentication response to the 5G base station to register the UE at the 5G base station.

16. The one or more non-transitory computer-readable media of claim 15, wherein the at least one authentication vector is a first authentication vector and the authentication response includes at least one second authentication vector, the operations further comprising at least one of:
storing the at least one second authentication vector at the AUSF; or
storing the at least one second authentication vector at an unstructured data storage function (UDSF).

17. The one or more non-transitory computer-readable media of claim 15, the operations further comprising:
receiving the authentication request via an N12 interface; and
sending the authentication get request via an N13 interface.

18. The one or more non-transitory computer-readable media of claim 15, wherein the AUSF is a common AUSF in communication with a plurality of UDMs that are associated with respective geographic regions.

19. The one or more non-transitory computer-readable media of claim 15, wherein the authentication response includes at least five authentication and key agreement (AKA) vectors.

20. The one or more non-transitory computer-readable media of claim 15, the operations further comprising:
determining a load level associated with the UDM; and
requesting a number of authentication vectors based on the load level;
wherein the authentication get request comprises the number of authentication vectors to be generated by the UDM.
